(19) United States
(12) Patent Application Publication
(10) Pub. No.: US 2025/0238895 A1
(43) Pub. Date: Jul. 24, 2025

(54) MULTI-EXIT VISUAL SYNTHESIS NETWORK BASED ON DYNAMIC PATCH COMPUTING

(71) Applicant: INTEL CORPORATION, Santa Clara, CA (US)

(72) Inventors: Ming Lu, Beijing (CN); Anbang Yao, Beijing (CN); Yanjie Pan, Shanghai (CN); Li Xu, Shanghai (CN); Yurong Chen, Beijing (CN)

(21) Appl. No.: 18/853,619

(22) PCT Filed: May 6, 2022
(86) PCT No.: PCT/CN2022/091124

§ 371 Date: Oct. 2, 2024

(51) Int. Cl. G06T 3/4053; G06T 5/70; G06T 5/73

(52) U.S. Cl. CPC G06T 3/4053; G06T 5/70; G06T 5/73; G06T 2207/20021; G06T 2207/20081

(57) ABSTRACT

The application relates to a multi-exit visual synthesis network (VSN) based on dynamic patch computing. A method for visual synthesis is provided and includes: splitting an input image into multiple input patches; performing a synthesis process on each input patch with a first layer to an i^{th} exit layer of a multi-exit VSN to obtain an i^{th} intermediate synthesis patch, where i is an index of an intermediate exit of the VSN and predetermined as an integer greater than or equal to 1; predicting an incremental improvement of a (i+1)^{th} intermediate synthesis patch relative to the i^{th} intermediate synthesis patch based on features in the i^{th} intermediate synthesis patch; determining a final exit of the VSN and a final synthesis patch for the input patch based on the predicted incremental improvement; and merging respective final synthesis patches for the multiple input patches to generate an output image.

### CROSS REFERENCE TO PRIOR APPLICATION

This application is a national stage application, filed under 35 U.S.C. § 371, of International Patent Application No. PCT/CN2022/091124, filed on May 6, 2022, titled “MULTI-EXIT VISUAL SYNTHESIS NETWORK BASED ON DYNAMIC PATCH COMPUTING,” which is incorporated herein by reference in its entirety.

### TECHNICAL FIELD

Embodiments described herein generally relate to visual processing, and more particularly relate to a multi-exit visual synthesis network based on dynamic patch computing (DPC).

### BACKGROUND

Since the future of computing is heterogeneous, scalability is a very important problem for visual synthesis such as image super-resolution (SR) on generic processors like Graphic Processing Units (GPUs). Recent works try to train a scalable network that can be deployed on platforms with different capacities. However, the scalable network may rely on a pixel-wise sparse convolution, which is not hardware-friendly and achieves limited practical speedup. Thus designing practically scalable solutions for visual synthesis is still under-explored.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates a practical speedup comparison of an image SR network based on unstructured pixel-wise sparsity and patch-wise sparsity with a same sparsity ratio;

FIG. 2 illustrates an example pipeline of a conventional image SR network;

FIG. 3 illustrates an example pipeline of an image SR network based on dynamic patch computing (DPC) according to some embodiments of the disclosure;

FIG. 4 illustrates visualization of early-exit patches of an image during processing by an image SR network based on DPC according to some embodiments of the disclosure;

FIG. 5a and FIG. 5b illustrate quantitative results of accuracy-efficiency trade-off obtained by an example multi-exit image SR network based on DPC according to some embodiments of the present disclosure;

FIG. 6 illustrates a performance comparison among a conventional image SR network, an existing scalable image SR network and an image SR network based on DPC according to some embodiments of the present disclosure;

FIG. 7 illustrates an example process for visual synthesis with a multi-exit visual synthesis network (VSN) based on DPC according to some embodiments of the disclosure;

FIG. 8 is a block diagram illustrating components, according to some example embodiments, able to read instructions from a machine-readable or computer-readable medium and perform any one or more of the methodologies discussed herein;

FIG. 9 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

Since the future of computing is heterogeneous, scalability is a very important problem for visual synthesis such as image SR on generic processors like GPUs. Recent works try to train a scalable network that can be deployed on platforms with different capacities. However, the scalable network may rely on a pixel-wise sparse convolution, which is not hardware-friendly and achieves limited practical speedup. Thus designing practically scalable solutions for visual synthesis is still under-explored.

In this disclosure, a practically scalable multi-exit visual synthesis network (VSN) based on image patches is proposed to solve the problem of scalability and meanwhile consider the trade-off between accuracy and efficiency. With the proposed multi-exit VSN, an input image may be firstly split into multiple patches, then for each patch, a synthesis process based on an dynamic patch computing (DPC) scheme may be performed on the patch so as to obtain a processed patch (also called a final synthesis patch), and finally all processed patches may be merged to generate an output image. The DPC scheme may be based on a classic concept of early exit for a deep learning neural network. However, it is noted that although there are a lot of solutions to apply the early exit to visual understanding tasks, the DPC scheme is totally different from the early exit in visual understanding tasks such as image classification. For the visual understanding tasks, the input image is processed uniformly, while the proposed multi-exit VSN adaptively handles different patches in the input image.

In addition, according to the proposed multi-exit VSN, a patch-wise sparse convolution may be applied to improve efficiency during inference. In other words, the visual synthesis network may be trained based on a patch-wise sparsity pattern, and then a synthesis process may be performed by the visual synthesis network based on a patch-wise sparse convolution corresponding to the patch-wise sparsity pattern.

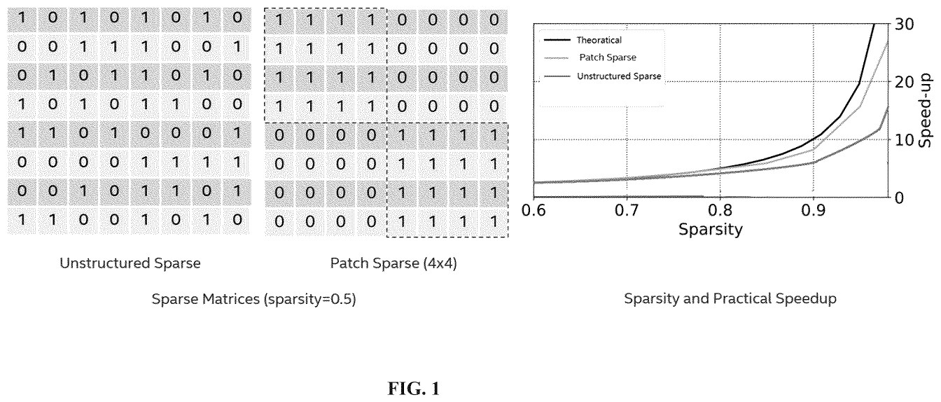

FIG. 1 illustrates a practical speedup comparison of an image SR network based on unstructured pixel-wise sparsity and patch-wise sparsity with a same sparsity ratio (also simply referred to as sparsity herein). The comparison result in FIG. 1 may be obtained according to experimental data for a same image SR network based on unstructured pixel-wise sparsity and patch-wise sparsity. As shown in FIG. 1, a practical speedup closer to theoretical speedup may be achieved by the image SR network by use of patch-wise sparsity instead of pixel-wise sparsity.

According to the present disclosure, during inference with the proposed multi-exit VSN based on DPC, the number of performed layers may be adaptively adjusted for each patch of an input image instead of the whole input image. Therefore, the proposed multi-exit VSN based on DPC can achieve the practical speedup close to the theoretical speedup.

In this disclosure, the multi-exit VSN may include an image SR network, an image denoising network, an image deblurring network or the like. Since there is no down-sampling in the multi-exit VSN, a shared up-sampler may be used in the VSN to obtain processed patches at different exits. Only for purpose of illustration, an image SR network is taken as an example of the VSN to describe a pipeline of the VSN in details.

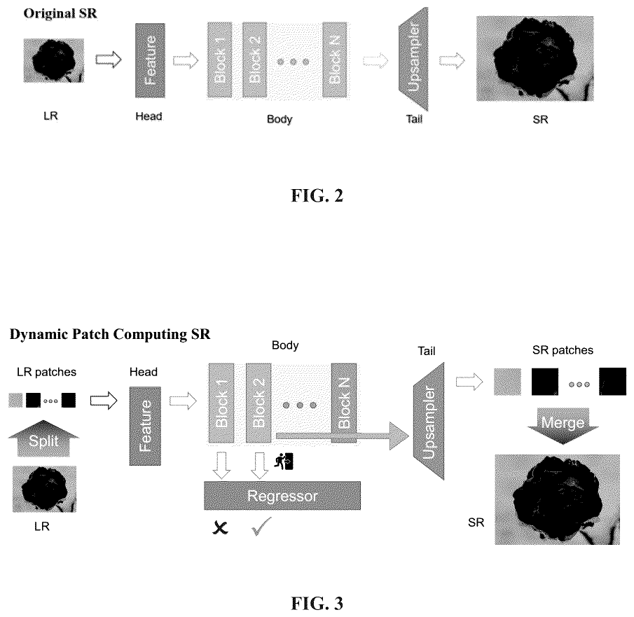

FIG. 2 illustrates an example pipeline of a conventional image SR network. As shown in FIG. 2, the conventional image SR network such as Enhanced Deep Residual Network for Single Image Super-Resolution (EDSR) or Residual Channel Attention Network (RCAN) has a neat topology consisting of three stages: head, body and tail. The head stage may convert an input low-resolution (LR) image into LR features, and the body stage may learn an end-to-end mapping of LR features to high-resolution (HR) features. Finally, the tail stage may convert the HR features into an output SR image. Among the three stages, the body stage is the most time-consuming stage since it consists of several cascaded layers.

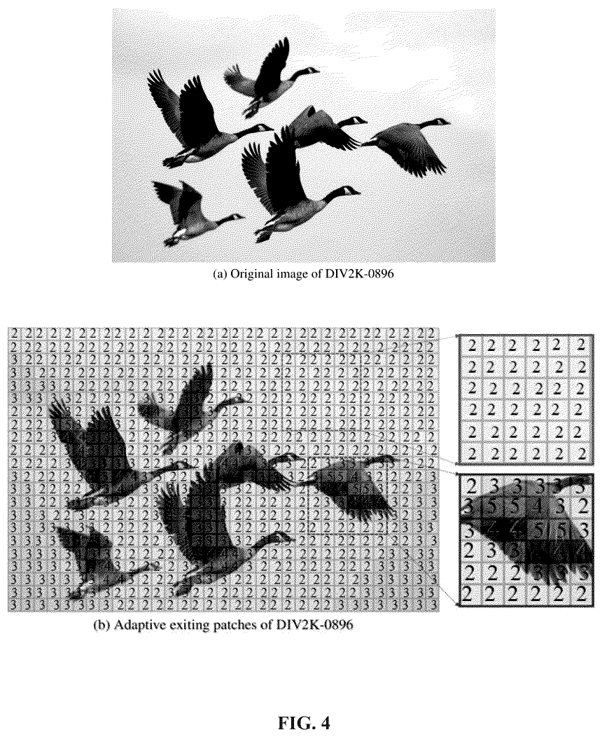

As mentioned above, according to the proposed multi-exit VSN based on DPC, the number of performed layers during inference may be adaptively adjusted for each patch of the input image. FIG. 3 illustrates an example pipeline of an image SR network based on DPC according to some embodiments of the disclosure. The image SR network may be a multi-exit SR network, which means the SR network may include a number of exit layers where an inference procedure may exit and an inference result obtained by use of the performed layers may be output as a final inference result.

As shown in FIG. 3, the input LR image may be firstly split into multiple LR patches. For each LR patch, a SR process may be performed on the LR patch with a first layer to an i^{th} exit layer of the multi-exit SR network to obtain an i^{th} intermediate patch having a feature improvement relative to the LR patch, where i is an exit index between 1 and a number of exits in the multi-exit SR network.

According to some embodiments of the present disclosure, a regressor may be applied to predict an incremental improvement of a (i+1)^{th} intermediate patch relative to the i^{th} intermediate patch based on features in the i^{th} intermediate patch. In this disclosure, the (i+1)^{th} intermediate patch may indicate an intermediate patch that may be obtained by performing the SR process on the LR patch with a first layer to an (i+1)^{th} exit layer of the multi-exit SR network, and the incremental improvement of the (i+1)^{th} intermediate patch relative to the i^{th} intermediate patch may indicate an improvement of HR features in the (i+1)^{th} intermediate patch relative to HR features in the i^{th} intermediate patch.

When the incremental improvement predicted at the i^{th} exit layer is below a predetermined threshold, the SR process for the LR patch may exit from the i^{th} exit layer, the i^{th} exit may be determined as a final exit for the LR patch and the i^{th} intermediate patch may be determined as a final SR patch for the LR patch; otherwise, i may be incremented by 1 and the SR process may continue to the (i+1)^{th} exit layer and the incremental improvement may be further predicted at the (i+1)^{th} exit layer until the incremental improvement is below the predetermined threshold or all layers in the VSN have been traversed by the SR process. It is easily understood that the predetermined threshold may be adjusted based on a trade-off between accuracy and efficiency of the multi-exit SR network. After respective SR patches for all the LR patches are obtained, the SR patches may be merged to generate the output SR image.

According to the embodiments, the regressor may be defined as Rᵢ=σ(W*g(Fᵢ)+b) for the i^{th} exit layer, where Fᵢ represents a set of features in the i^{th} intermediate patch, Rᵢ represents a predicted incremental improvement of the (i+1)^{th} intermediate patch relative to the i^{th} intermediate patch, σ is a tanh function, g is a global average pooling operation, W and b are respectively a weight and a bias of the multi-exit SR network.

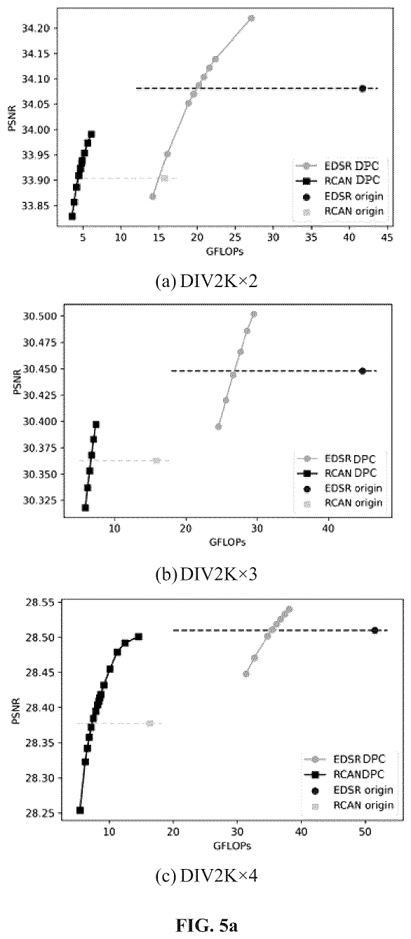

Since the patches in the input image may have various restoration difficulties, the exit layers for individual patches may be different. FIG. 4 illustrates visualization of early-exit patches of an image during processing by an image SR network based on DPC according to some embodiments of the disclosure. As shown in FIG. 4, for the patches in smooth regions of the input image, the SR process may exit at an early exit layer, e.g. the number of the performed layers may be 2 or 3, since these patches are easy to be restored; but for the patches in complicated regions of the input image, the SR process may exit at a later exit layer, e.g. the number of the performed layers may be 4 or 5, since these patches are hard to be restored. This result is consistent with the motivation of applying appropriate networks for various restoration difficulties.

As described above, the multi-exit SR network may include multiple exit layers, and the SR process with the multi-exit SR network may probably finish at any exit layer. Therefore, the training process of the multi-exit SR network may be different from a training process of the conventional SR network.

Specifically, the multi-exit SR network may be denoted as fᵢ, where i is the exit index between 1 and the number of exits in the multi-exit SR network. For a LR patch x, a SR patch yᵢ obtained by the SR process with the first layer to the i^{th} exit layer of the multi-exit SR network may be denoted as yᵢ=fᵢ(x). Accordingly, the multi-exit SR network may be trained based on a sum of a reconstruction loss Lᵢ=|yᵢ−y_{gt}| for each exit layer in the multi-exit SR network, where y_{gt} represents a ground-truth SR patch for the LR patch. In other words, the training process for the multi-exit SR network may be expressed with equations (1) and (2) as follows.

$${L}_{i} = \vert {y}_{i} - {y}_{gt} \vert \qquad ( 1 )$$

$${min}_{θ} \sum ( {L}_{i} ) \qquad ( 2 )$$

In addition, the regressor Rᵢ may be trained based on a regression loss Jᵢ defined as a L2 loss between Rᵢ and a ground-truth incremental improvement Iᵢ at the i^{th} exit layer and expressed with equation (3) as follows.

$${J}_{i} = {‖ {R}_{i} - {I}_{i} ‖}_{2}^{2} \qquad ( 3 )$$

Therefore, the multi-exit SR network may be trained based on a sum of a total loss including the reconstruction loss Lᵢ and the regression loss Jᵢ of the regressor for each exit layer in the multi-exit SR network. In this case, the training process for the multi-exit SR network may be expressed with equation (4) as follows.

$${min}_{θ} \sum ( {L}_{i} + λ {J}_{i} ) \qquad ( 4 )$$

In equation (4), λ is a hyper-parameter for balancing the reconstruction loss Lᵢ and the regression loss Jᵢ.

In the foregoing description, the architecture of the multi-exit SR network based on DPC and the training process for the multi-exit SR network have been described. The multi-exit SR network based on DPC is a practically scalable network, which can be deployed on platforms with different capacities. Also, the trade-off between accuracy and efficiency can be achieved by adjusting the threshold for the incremental improvement of each exit layer.

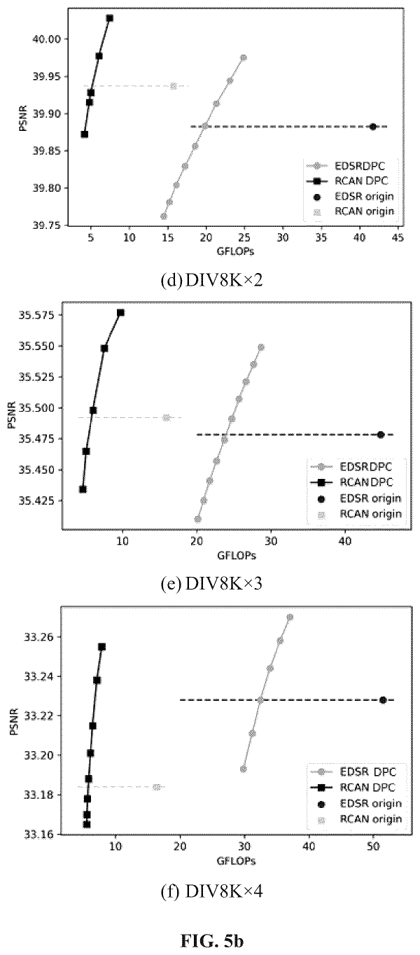

In order to demonstrate the advantages of the proposed solution in the disclosure, extensive experiments across various SR backbones, datasets and scaling factors have been conducted. FIG. 5a and FIG. 5b illustrate quantitative results of accuracy-efficiency trade-off obtained by an example multi-exit image SR network based on DPC according to some embodiments of the present disclosure. To evaluate the effectiveness of the proposed solution, EDSR and RCAN are used as the backbones of the multi-exit SR network, and the DPC scheme is applied to EDSR and RCAN respectively. The EDSR based on the DPC scheme may be referred to as the EDSR-DPC, and the RCAN based on the DPC scheme may be referred to as the RCAN-DPC. An exit every 4 blocks may be set for the EDSR-DPC, and thus the EDSR-DPC may include 8 exits. Similarly, an exit at every residual group may be set for the RCAN-DPC, and thus the RCAN-DPC may include 10 exits. The experimental results obtained by use of DIV2K dataset for scaling factors ×2, ×3, ×4 are shown in FIG. 5a, and the experimental results obtained by use of DIV8K dataset for scaling factors ×2, ×3, ×4 are shown in FIG. 5b. In FIG. 5a and FIG. 5b, the EDSR-origin indicates the conventional EDSR, the RCAN-origin indicates the conventional RCAN, GFLOPS is the acronym of Giga Floating-point Operations which indicates an average FLOPs for all 32×32 LR patches, and PSNR is the acronym of Peak Signal to Noise Ratio which is calculated on the complete image.

From the illustration of FIG. 5a and FIG. 5b, it can be seen that with the DPC scheme, it is possible to significantly reduce the computational cost of EDSR and RCAN across different scaling factors. For example, RCAN-DPC only needs 40%, 42%, and 44% of original computational cost on the DIV2K dataset for scaling factors ×2, ×3 and ×4.

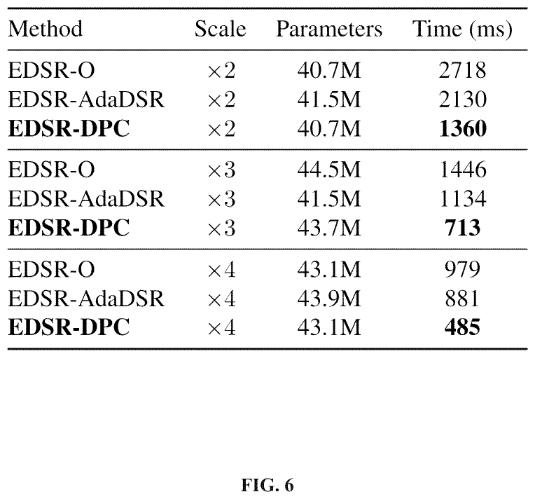

In addition, FIG. 6 illustrates a performance comparison among a conventional image SR network (EDSR-O), an existing scalable image SR network (EDSR-AdaDSR) and an image SR network based on DPC (EDSR-DPC) according to some embodiments of the present disclosure. The EDSR-AdaDSR is also a scalable image SR network which leveraging the adaptive inference networks for deep SISR (AdaDSR). The details of AdaDSR is described in “Deep adaptive inference networks for single image super-resolution”, Liu, M., Zhang, Z., Hou, L., Zuo, W., & Zhang, L., 2020 August, European Conference on Computer Vision (pp. 131-148), Springer, Cham. The AdaDSR is based on pixel-wise sparse convolution to achieve speedup. However, pixel-wise sparse convolution is not hardware-friendly on modern GPUs, thus there exists a gap between theoretical and practical speedup gains as shown in FIG. 1. Taking EDSR as the backbone, the conventional SR network EDSR-O, the EDSR based on AdaDSR and the EDSR based on DPC are compared on different scaling factors and under the same accuracy as baseline. As can be seen from FIG. 6, with similar parameters, the EDSR-DPC is faster than the EDSR-AdaDSR in practice when testing on NVIDIA 2080Ti.

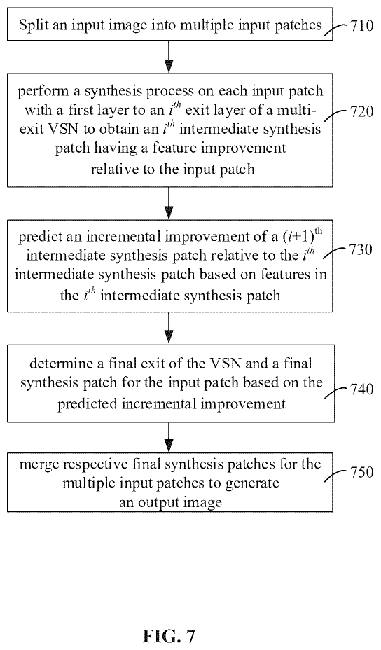

FIG. 7 illustrates an example process for visual synthesis with a multi-exit visual synthesis network (VSN) based on DPC according to some embodiments of the disclosure. As mentioned above, the proposed DPC scheme can be applied to a multi-exit VSN such as an image SR network, an image denoising network, or an image deblurring network. In general, the process for visual synthesis with the multi-exit VSN based on DPC may include operations 710 to 750 and may be implemented by a processor circuitry.

At operation 710, the processor circuitry may split an input image into multiple input patches.

At operation 720, the processor circuitry may perform a synthesis process on each input patch with a first layer to an i^{th} exit layer of the multi-exit VSN to obtain an i^{th} intermediate synthesis patch having a feature improvement relative to the input patch. Here, i is an index of an intermediate exit of the VSN and predetermined as an integer greater than or equal to 1.

At operation 730, the processor circuitry may predict an incremental improvement of a (i+1)^{th} intermediate synthesis patch relative to the i^{th} synthesis patch based on features in the i^{th} intermediate synthesis patch.

According to some embodiments, the processor circuitry may predict the incremental improvement with a regressor defined as Rᵢ=σ(W*g(Fᵢ)+b) for the i^{th} exit layer, where Fᵢ represents a set of features in the i^{th} intermediate synthesis patch, Rᵢ represents a predicted incremental improvement of the (i+1)^{th} intermediate synthesis patch relative to the i^{th} intermediate synthesis patch, σ is a tanh function, g is a global average pooling operation, W and b are respectively a weight and a bias of the multi-exit VSN.

At operation 740, the processor circuitry may determine a final exit of the VSN and a final synthesis patch for the input patch based on the predicted incremental improvement.

According to some embodiments, the processor circuitry may determine an i^{th} exit as the final exit and the i^{th} intermediate synthesis patch as the final synthesis patch for the input patch when the incremental improvement is below a predetermined threshold, otherwise, increment i and continue to perform the synthesis process and predict the incremental improvement until the incremental improvement is below the predetermined threshold or all layers in the VSN have been traversed by the synthesis process.

According to some embodiments, the processor circuitry may adjust the predetermined threshold based on a trade-off between accuracy and efficiency of the multi-exit VSN.

At operation 750, the processor circuitry may merge respective final synthesis patches for the multiple input patches to generate an output image.

According to some embodiments, a regression loss Jᵢ of the regressor may be defined as a L2 loss between Rᵢ and a ground-truth incremental improvement Iᵢ at the i^{th} exit layer.

According to some embodiments, the multi-exit VSN may be trained based on a sum of a reconstruction loss Lᵢ=|yᵢ−y_{gt}| for each exit layer in the multi-exit VSN, where yᵢ represents the i^{th} intermediate synthesis patch, and y_{gt} represents a ground-truth synthesis patch for the input patch.

According to some embodiments, the multi-exit VSN may be trained based on a sum of a total loss comprising the reconstruction loss Lᵢ and a regression loss Jᵢ of the regressor for each exit layer in the multi-exit VSN. The total loss may be defined as Lᵢ+λJᵢ, where λ is a hyper-parameter for balancing the reconstruction loss Lᵢ and the regression loss Jᵢ.

According to some embodiments, the multi-exit VSN may be trained based on a patch-wise sparsity pattern and the synthesis process may be performed based on a patch-wise sparse convolution corresponding to the patch-wise sparsity pattern.

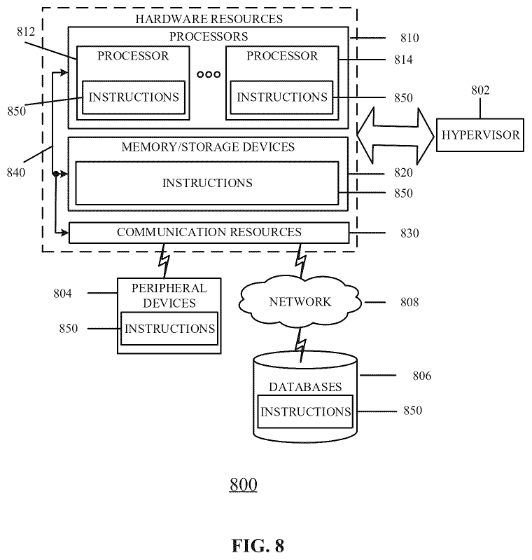

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 820 may include main memory, disk storage, or any suitable combination thereof. The memory/storage devices 820 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

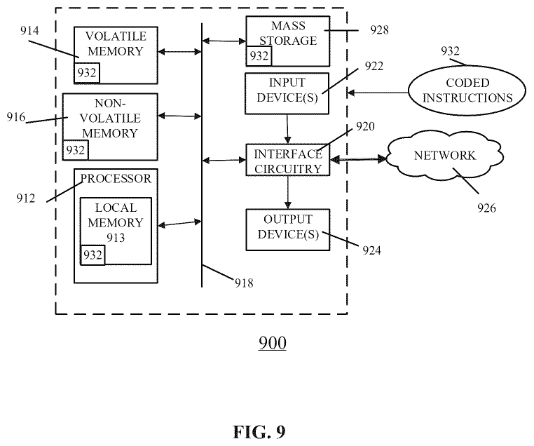

FIG. 9 is a block diagram of an example processor platform in accordance with some embodiments of the disclosure. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes interface circuitry 920. The interface circuitry 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuitry 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 920 of the illustrated example, thus, typically includes a graphics driver card, a graphics driver chip and/or a graphics driver processor.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 920 may include a training dataset inputted through the input device(s) 922 or retrieved from the network 926.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives.

Machine executable instructions 932 may be stored in the mass storage device 928, in the volatile memory 914, in the non-volatile memory 916, and/or on a removable non-transitory computer readable storage medium such as a CD or DVD.

### Additional Notes and Examples

Example 1 includes an apparatus for visual synthesis, comprising: interface circuitry; and processor circuitry coupled to the interface circuitry and configured to: split an input image received via the interface circuitry into multiple input patches; perform a synthesis process on each input patch with a first layer to an i^{th} exit layer of a multi-exit visual synthesis network (VSN) to obtain an i^{th} intermediate synthesis patch, where i is an index of an intermediate exit of the VSN and predetermined as an integer greater than or equal to 1; predict an incremental improvement of a (i+1)^{th} intermediate synthesis patch relative to the i^{th} intermediate synthesis patch based on features in the i^{th} intermediate synthesis patch; determine a final exit of the VSN and a final synthesis patch for the input patch based on the predicted incremental improvement; and merge respective final synthesis patches for the multiple input patches to generate an output image.

Example 2 includes the apparatus of Example 1, wherein the processor circuitry is configured to determine the final exit of the VSN and the final synthesis patch for the input patch by: determining an i^{th} exit as the final exit and the i^{th} intermediate synthesis patch as the final synthesis patch for the input patch when the incremental improvement is below a predetermined threshold, otherwise, incrementing i and continuing to perform the synthesis process and predict the incremental improvement until the incremental improvement is below the predetermined threshold or all layers in the VSN have been traversed by the synthesis process.

Example 3 includes the apparatus of Example 2, wherein the processor circuitry is further configured to adjust the predetermined threshold based on a trade-off between accuracy and efficiency of the multi-exit VSN.

Example 4 includes the apparatus of any of Examples 1 to 3, wherein the processor circuitry is configured to predict the incremental improvement with a regressor defined as Rᵢ=σ(W*g(Fᵢ)+b) for the i^{th} exit layer, where Fᵢ represents a set of features in the i^{th} intermediate synthesis patch, Rᵢ represents a predicted incremental improvement of the (i+1)^{th} intermediate synthesis patch relative to the i^{th} intermediate synthesis patch, σ is a tanh function, g is a global average pooling operation, W and b are respectively a weight and a bias of the multi-exit VSN.

Example 5 includes the apparatus of Example 4, wherein a regression loss Jᵢ of the regressor is defined as a L2 loss between Rᵢ and a ground-truth incremental improvement Iᵢ at the i^{th} exit layer.

Example 6 includes the apparatus of any of Examples 1 to 5, wherein the multi-exit VSN is trained based on a sum of a reconstruction loss Lᵢ=|yᵢ−y_{gt}| for each exit layer in the multi-exit VSN, where yᵢ represents the i^{th} intermediate synthesis patch, and y_{gt} represents a ground-truth synthesis patch for the input patch.

Example 7 includes the apparatus of Example 6, wherein the multi-exit VSN is trained based on a sum of a total loss comprising the reconstruction loss Lᵢ and a regression loss Jᵢ of the regressor for each exit layer in the multi-exit VSN.

Example 8 includes the apparatus of Example 7, wherein the total loss is defined as Lᵢ+λJᵢ, where λ is a hyper-parameter for balancing the reconstruction loss Lᵢ and the regression loss Jᵢ.

Example 9 includes the apparatus of any of Examples 1 to 8, wherein the multi-exit VSN is trained based on a patch-wise sparsity pattern and the processor circuitry is configured to perform the synthesis process based on a patch-wise sparse convolution corresponding to the patch-wise sparsity pattern.

Example 10 includes the apparatus of any of Examples 1 to 8, wherein the multi-exit VSN comprises an image super-resolution network, an image denoising network, or an image deblurring network.

Example 11 includes a method for visual synthesis, comprising: splitting an input image into multiple input patches; performing a synthesis process on each input patch with a first layer to an i^{th} exit layer of a multi-exit visual synthesis network (VSN) to obtain an i^{th} intermediate synthesis patch, where i is an index of an intermediate exit of the VSN and predetermined as an integer greater than or equal to 1; predicting an incremental improvement of a (i+1)^{th} intermediate synthesis patch relative to the i^{th} intermediate synthesis patch based on features in the i^{th} intermediate synthesis patch; determining a final exit of the VSN and a final synthesis patch for the input patch based on the predicted incremental improvement; and merging respective final synthesis patches for the multiple input patches to generate an output image.

Example 12 includes the method of Example 11, wherein determining the final exit of the VSN and the final synthesis patch for the input patch comprises: determining an i^{th} exit as the final exit and the i^{th} intermediate synthesis patch as the final synthesis patch for the input patch when the incremental improvement is below a predetermined threshold, otherwise, incrementing i and continuing to perform the synthesis process and predict the incremental improvement until the incremental improvement is below the predetermined threshold or all layers in the VSN have been traversed by the synthesis process.

Example 13 includes the method of Example 12, further comprising: adjusting the predetermined threshold based on a trade-off between accuracy and efficiency of the multi-exit VSN.

Example 14 includes the method of any of Examples 11 to 13, wherein predicting the incremental improvement comprises predicting the incremental improvement with a regressor defined as Rᵢ=σ(W*g(Fᵢ)+b) for the i^{th} exit layer, where Fᵢ represents a set of features in the i^{th} intermediate synthesis patch, Rᵢ represents a predicted incremental improvement of the (i+1)^{th} intermediate synthesis patch relative to the i^{th} intermediate synthesis patch, σ is a tanh function, g is a global average pooling operation, W and b are respectively a weight and a bias of the multi-exit VSN.

Example 15 includes the method of Example 14, wherein a regression loss Jᵢ of the regressor is defined as a L2 loss between Rᵢ and a ground-truth incremental improvement Iᵢ at the i^{th} exit layer.

Example 16 includes the method of any of Examples 11 to 15, wherein the multi-exit VSN is trained based on a sum of a reconstruction loss Lᵢ=|yᵢ−y_{gt}| for each exit layer in the multi-exit VSN, where yᵢ represents the i^{th} intermediate synthesis patch, and y_{gt} represents a ground-truth synthesis patch for the input patch.

Example 17 includes the method of Example 16, wherein the multi-exit VSN is trained based on a sum of a total loss comprising the reconstruction loss Lᵢ and a regression loss Jᵢ of the regressor for each exit layer in the multi-exit VSN.

Example 18 includes the method of Example 17, wherein the total loss is defined as Lᵢ+λJᵢ, where λ is a hyper-parameter for balancing the reconstruction loss Lᵢ and the regression loss Jᵢ.

Example 19 includes the method of any of Examples 11 to 18, wherein the multi-exit VSN is trained based on a patch-wise sparsity pattern and the synthesis process is performed based on a patch-wise sparse convolution corresponding to the patch-wise sparsity pattern.

Example 20 includes the method of any of Examples 11 to 18, wherein the multi-exit VSN comprises an image super-resolution network, an image denoising network, or an image deblurring network.

Example 21 includes a computer-readable medium having instructions stored thereon, wherein the instructions, when executed by processor circuitry, cause the processor circuitry to perform the method of any of Examples 11 to 20.

Example 22 includes a device for visual synthesis, comprising means for performing the method of any of Examples 11 to 20.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus for visual synthesis, comprising: interface circuitry; and processor circuitry coupled to the interface circuitry and configured to:
split an input image received via the interface circuitry into multiple input patches;
perform a synthesis process on each input patch with a first layer to an i^{th} exit layer of a multi-exit visual synthesis network (VSN) to obtain an i^{th} intermediate synthesis patch, where i is an index of an intermediate exit of the VSN and predetermined as an integer greater than or equal to 1;
predict an incremental improvement of a (i+1)^{th} intermediate synthesis patch relative to the i^{th} intermediate synthesis patch based on features in the i^{th} intermediate synthesis patch;
determine a final exit of the VSN and a final synthesis patch for the input patch based on the predicted incremental improvement; and
merge respective final synthesis patches for the multiple input patches to generate an output image.

2. The apparatus of claim 1, wherein the processor circuitry is configured to determine the final exit of the VSN and the final synthesis patch for the input patch by: determining an i^{th} exit as the final exit and the i^{th} intermediate synthesis patch as the final synthesis patch for the input patch when the incremental improvement is below a predetermined threshold, otherwise, incrementing i and continuing to perform the synthesis process and predict the incremental improvement until the incremental improvement is below the predetermined threshold or all layers in the VSN have been traversed by the synthesis process.

3. The apparatus of claim 2, wherein the processor circuitry is further configured to adjust the predetermined threshold based on a trade-off between accuracy and efficiency of the multi-exit VSN.

4. The apparatus of claim 1, wherein the processor circuitry is configured to predict the incremental improvement with a regressor defined as Rᵢ=σ(W*g(Fᵢ)+b) for the i^{th} exit layer, where Fᵢ represents a set of features in the i^{th} intermediate synthesis patch, Rᵢ represents a predicted incremental improvement of the (i+1)^{th} intermediate synthesis patch relative to the i^{th} intermediate synthesis patch, σ is a tanh function, g is a global average pooling operation, W and b are respectively a weight and a bias of the multi-exit VSN.

5. The apparatus of claim 4, wherein a regression loss Jᵢ of the regressor is defined as a L2 loss between Rᵢ and a ground-truth incremental improvement Iᵢ at the i^{th} exit layer.

6. The apparatus of claim 1, wherein the multi-exit VSN is trained based on a sum of a reconstruction loss Lᵢ=|yᵢ−y_{gt}| for each exit layer in the multi-exit VSN, where yᵢ represents the i^{th} intermediate synthesis patch, and y_{gt} represents a ground-truth synthesis patch for the input patch.

7. The apparatus of claim 6, wherein the multi-exit VSN is trained based on a sum of a total loss comprising the reconstruction loss Lᵢ and a regression loss Jᵢ of the regressor for each exit layer in the multi-exit VSN.

8. The apparatus of claim 7, wherein the total loss is defined as Lᵢ+λJᵢ, where λ is a hyper-parameter for balancing the reconstruction loss Lᵢ and the regression loss Jᵢ.

9. The apparatus of claim 1, wherein the multi-exit VSN is trained based on a patch-wise sparsity pattern and the processor circuitry is configured to perform the synthesis process based on a patch-wise sparse convolution corresponding to the patch-wise sparsity pattern.

10. The apparatus of claim 1, wherein the multi-exit VSN comprises an image super-resolution network, an image denoising network, or an image deblurring network.

11. A method for visual synthesis, comprising:
splitting an input image into multiple input patches;
performing a synthesis process on each input patch with a first layer to an i^{th} exit layer of a multi-exit visual synthesis network (VSN) to obtain an i^{th} intermediate synthesis patch, where i is an index of an intermediate exit of the VSN and predetermined as an integer greater than or equal to 1;
predicting an incremental improvement of a (i+1)^{th} intermediate synthesis patch relative to the i^{th} intermediate synthesis patch based on features in the i^{th} intermediate synthesis patch;
determining a final exit of the VSN and a final synthesis patch for the input patch based on the predicted incremental improvement; and
merging respective final synthesis patches for the multiple input patches to generate an output image.

12. The method of claim 11, wherein determining the final exit of the VSN and the final synthesis patch for the input patch comprises: determining an i^{th} exit as the final exit and the i^{th} intermediate synthesis patch as the final synthesis patch for the input patch when the incremental improvement is below a predetermined threshold, otherwise, incrementing i and continuing to perform the synthesis process and predict the incremental improvement until the incremental improvement is below the predetermined threshold or all layers in the VSN have been traversed by the synthesis process.

13. (canceled)

14. The method of claim 11, wherein predicting the incremental improvement comprises predicting the incremental improvement with a regressor defined as Rᵢ=σ(W*g(Fᵢ)+b) for the i^{th} exit layer, where Fᵢ represents a set of features in the i^{th} intermediate synthesis patch, Rᵢ represents a predicted incremental improvement of the (i+1)^{th} intermediate synthesis patch relative to the i^{th} intermediate synthesis patch, σ is a tanh function, g is a global average pooling operation, W and b are respectively a weight and a bias of the multi-exit VSN.

15. (canceled)

16. The method of claim 11, wherein the multi-exit VSN is trained based on a sum of a reconstruction loss Lᵢ=|yᵢ−y_{gt}| for each exit layer in the multi-exit VSN, where yᵢ represents the i^{th} intermediate synthesis patch, and y_{gt} represents a ground-truth synthesis patch for the input patch.

17. The method of claim 16, wherein the multi-exit VSN is trained based on a sum of a total loss comprising the reconstruction loss Lᵢ and a regression loss Jᵢ of the regressor for each exit layer in the multi-exit VSN.

18. (canceled)

19. The method of claim 11, wherein the multi-exit VSN is trained based on a patch-wise sparsity pattern and the synthesis process is performed based on a patch-wise sparse convolution corresponding to the patch-wise sparsity pattern.

20. The method of claim 11, wherein the multi-exit VSN comprises an image super-resolution network, an image denoising network, or an image deblurring network.

21. One or more computer-readable media storing instructions executable to perform operations for training a target neural network, the operations comprising:
splitting an input image into multiple input patches;
performing a synthesis process on each input patch with a first layer to an i^{th} exit layer of a multi-exit visual synthesis network (VSN) to obtain an i^{th} intermediate synthesis patch, where i is an index of an intermediate exit of the VSN and predetermined as an integer greater than or equal to 1;
predicting an incremental improvement of a (i+1)^{th} intermediate synthesis patch relative to the i^{th} intermediate synthesis patch based on features in the i^{th} intermediate synthesis patch;
determining a final exit of the VSN and a final synthesis patch for the input patch based on the predicted incremental improvement; and
merging respective final synthesis patches for the multiple input patches to generate an output image.

22. (canceled)

23. The one or more non-transitory computer-readable media of claim 21, wherein determining the final exit of the VSN and the final synthesis patch for the input patch comprises: determining an i^{th} exit as the final exit and the i^{th} intermediate synthesis patch as the final synthesis patch for the input patch when the incremental improvement is below a predetermined threshold, otherwise, incrementing i and continuing to perform the synthesis process and predict the incremental improvement until the incremental improvement is below the predetermined threshold or all layers in the VSN have been traversed by the synthesis process.

24. The one or more non-transitory computer-readable media of claim 21, wherein predicting the incremental improvement comprises predicting the incremental improvement with a regressor defined as Rᵢ=σ(W*g(Fᵢ)+b) for the i^{th} exit layer, where Fᵢ represents a set of features in the i^{th} intermediate synthesis patch, Rᵢ represents a predicted incremental improvement of the (i+1)^{th} intermediate synthesis patch relative to the i^{th} intermediate synthesis patch, σ is a tanh function, g is a global average pooling operation, W and b are respectively a weight and a bias of the multi-exit VSN.
